(19) United States
(12) Patent Application Publication
(10) Pub. No.: US 2017/0352030 A1
(43) Pub. Date: Dec. 7, 2017

(54) ANONYMOUS MOBILE PAYMENT SYSTEM

(71) Applicant: Diip, LLC, Southfield, MI (US)

(72) Inventors: Brian Ferrilla, Detroit, MI (US); Steven Blackman, Philadelphia, PA (US)

(21) Appl. No.: 15/611,319

(22) Filed: Jun. 1, 2017

Related U.S. Application Data
(60) Provisional application No. 62/344,611, filed on Jun. 2, 2016.

(51) Int. Cl. G06Q 20/38; G06Q 20/20; G06Q 20/14; H04W 4/02; G06Q 20/02

(52) U.S. Cl. CPC G06Q 20/383; H04W 4/025; G06Q 20/027; G06Q 20/145; G06Q 20/204

(57) ABSTRACT

A method for a system and method of data processing whereby diners can pay their tab or check out from a merchant without having to disclose sensitive personal and financial information to the merchant. Upon arrival at a merchant's place of business, a unique random identifier code is generated through a mobile application. The unique random identifier code is associated with a user's payment information and the user's tab. After ordering menu items from a merchant, the user may pay its tab through the application and without disclosing identifying or financial information to the merchant.

### CROSS-REFERENCE TO RELATED APPLICATION(S) AND CLAIM OF PRIORITY

This application claims the benefit of and incorporated herein for all purposes, U.S. Provisional Patent Application Ser. No. 62/344,611; filed Jun. 2, 2016; in the name of Brian Ferrilla and titled “ANONYMOUS MOBILE PAYMENT SYSTEM.”

### BACKGROUND

### 1. Field

The present disclosure generally relates to data processing systems in the field of electronic payments. More specifically, this disclosure relates to a computer-implemented method for managing payments for restaurant dining, in a manner such that the purchaser's identity remains anonymous to the restaurant and its point of sale (“POS”) and payment systems.

### 2. Description of the Prior Art

Restaurant diners, or any customer in an establishment, often find waiting to settle their bill, tab or ticket (referred to generally and herein as a “tab”) to be tedious and time consuming. Current technology requires diners to spend an unacceptable amount of time waiting until they are free to leave after finishing their meal. Diners have to wait for their server to open a tab for their table at an often busy restaurant, bar or other establishment; they again have to wait for the server to bring them a bill. The diners prepare their payment and wait again for the waiter to return to collect it. Sometimes they wait for a waiter to split their tab amongst the diners. Finally, they wait for the server to run their credit or debit card, deliver change, and/or deliver a paid receipt.

While some technology allows diners to pay for their tab via mobile application through their smart phones, this current technology requires exposing and storing the diner's personal and financial identity to a payment system which it may not trust. In order to use these applications, diners must enter their credit card information, which in turn provides critical financial information to restaurants or bars, leaving diners vulnerable to credit card hackers and scammers.

### SUMMARY

The present disclosure provides for a system and method of data processing whereby diners can pay their tab or check out from a restaurant without having to disclose sensitive personal and financial information to the merchant.

Prior to arriving at a merchant's place of business, a user will create an account with a mobile application and will record his or her payment data. At the same time or after, a merchant will create its own account.

Upon arriving at a merchant's place of business, the user will open the mobile application on his or her mobile device or cellphone, which will utilize the mobile device's Global Positioning System to determine the user's location. The user will confirm his or her location by selecting the appropriate restaurant or bar in the application, at which point the mobile application will generate a unique random identifier code. The unique random identifier code is associated with the user's account through the mobile application only for that particular visit to the merchant's place of business including the merchant point of sale computer.

As part of using the system including the method of the present disclosure, the user will give the unique random identifier code to the waiter at the merchant's place of business. The waiter associates the unique random identifier code with the user's tab open at the merchant's point of sale computer. The merchant's point of sale computer then communicates this data to the mobile application, and the user will then be able to view his or her tab or check on his mobile device.

When the user has finished his or her meal and is ready to leave the restaurant, he or she may indicate so by making the appropriate selection on the mobile device. The application obtains a current total tab amount, displays that amount, and determines an extended total tab amount based on the current total tab amount and applicable taxes and fees. The application may also make suggestions for tip amounts, and can include that in the extended total tab amount as well. The user confirms that payment is to be made, at which point the application communicates with the merchant POS system to invoke a payment network gateway computer to cause payment of the extended total tab amount to be authorized from the user account.

The application then obtains a final total tab amount for the tab associated with the unique random identifier code, and provides payment from the user's account to the merchant's account through a payment network gateway computer. The user's payment information is never disclosed to the merchant. The unique random identifier code is the only point of reference linking the user to his tab.

In one embodiment of the application, the user is prompted to take a self-portrait photo at the same time that the application generates the unique random identifier code. The application communicates to the merchant's point of sale computer the self-portrait photo and the unique random identifier code and will then, either automatically or through prompting of the waiter, open a new guest tab associated with the random identifier code. The waiter will take the user's order normally and will associate the order with the identifiable face of the user consistent with the self-portrait photo, which appears on the merchant's point of sale computer.

An additional feature to the application allows the application to suggest transportation service in the event that the number of alcoholic drinks ordered at the merchant exceeds a certain minimum. This minimum is calculated by an algorithm based upon the number and sex of the individuals in the user's party which may be entered by the user/waiter. In the event that the number of drinks ordered on the tab, check or ticket exceeds that minimum, the application may then be used to facilitate communication with a transportation service.

The application also allows users to rate the service at the merchant's place of business on a scale of zero to five stars. The application prompts the user to describe the service or reason for the rating. This description is recorded and transmitted to the merchant.

### BRIEF DESCRIPTION OF THE DRAWINGS

Other advantages of the system and method of the present disclosure will be readily appreciated, as the same becomes better understood by reference to the following Detailed Description when considered in connection with the accompanying drawings wherein:

FIG. 1 is a networked computer environment using a system having an application using a method of the present disclosure.

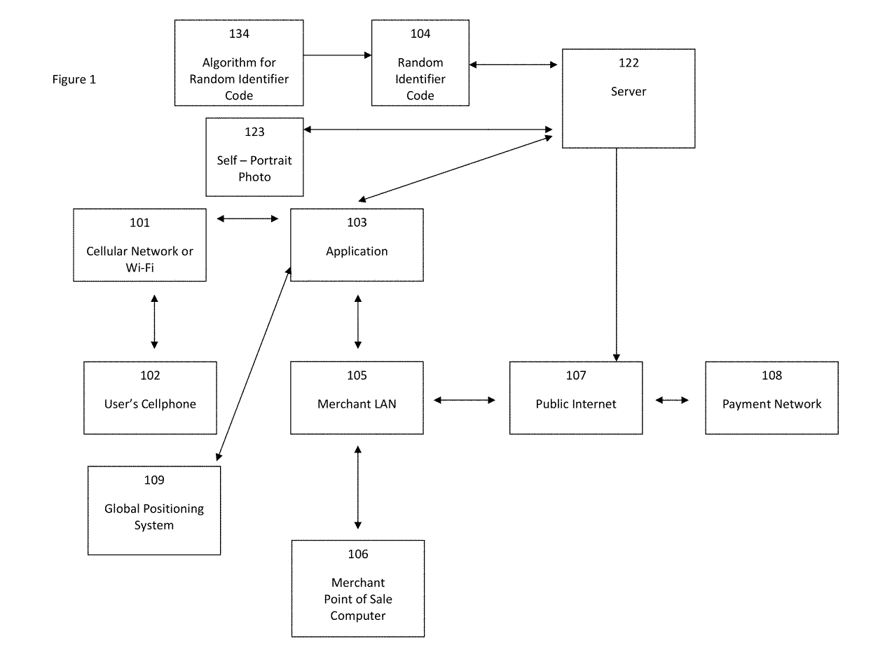

FIG. 2 is another example of a networked computer environment using a system having an application using a method of the present disclosure.

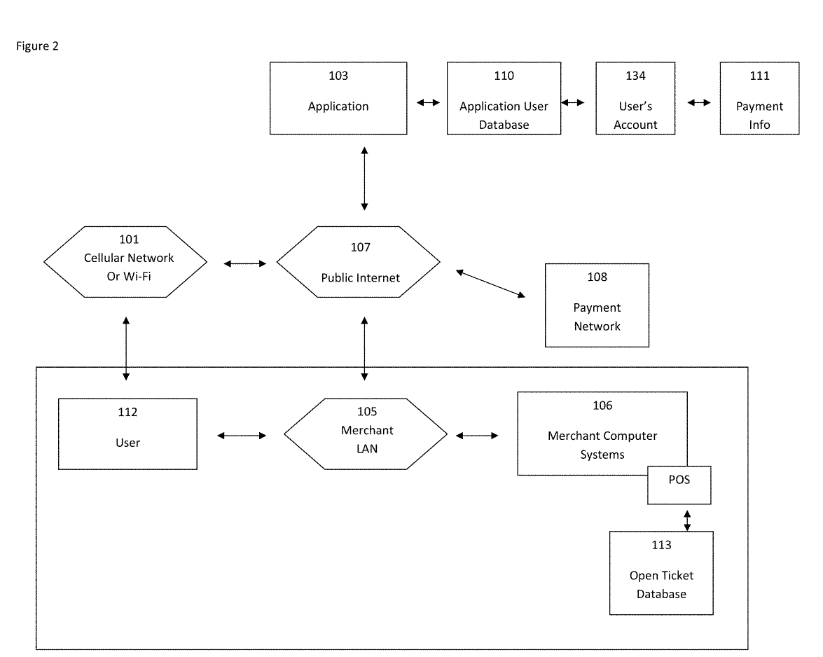

FIG. 3 is a flow chart explaining another potential embodiment of the invention.

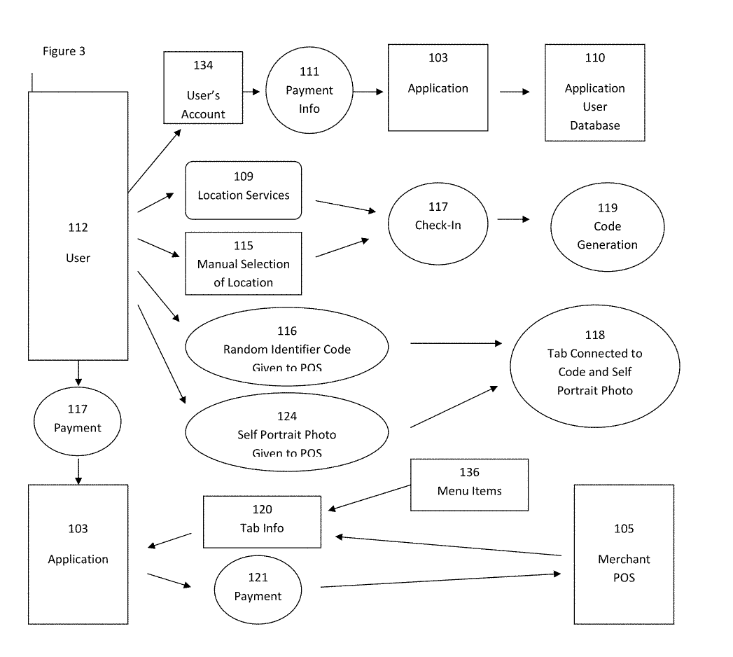

FIG. 4 is a flow chart explaining an additional aspect of the present disclosure involving provision of communication with a transportation service.

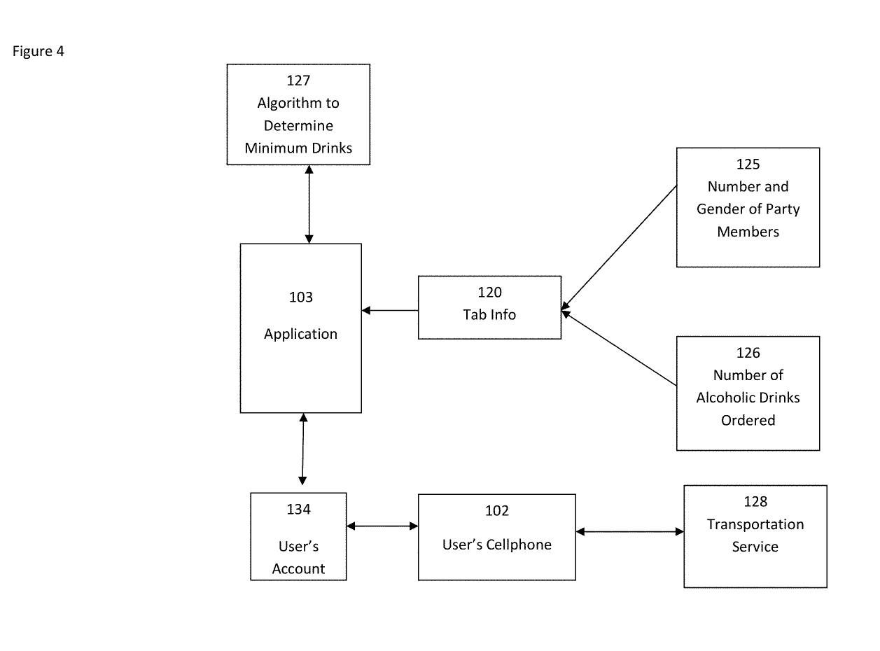

FIG. 5 is a flow chart explaining an additional aspect of the present disclosure involving the user's favorite items from the merchant, as well as an evaluation and rating for the merchant.

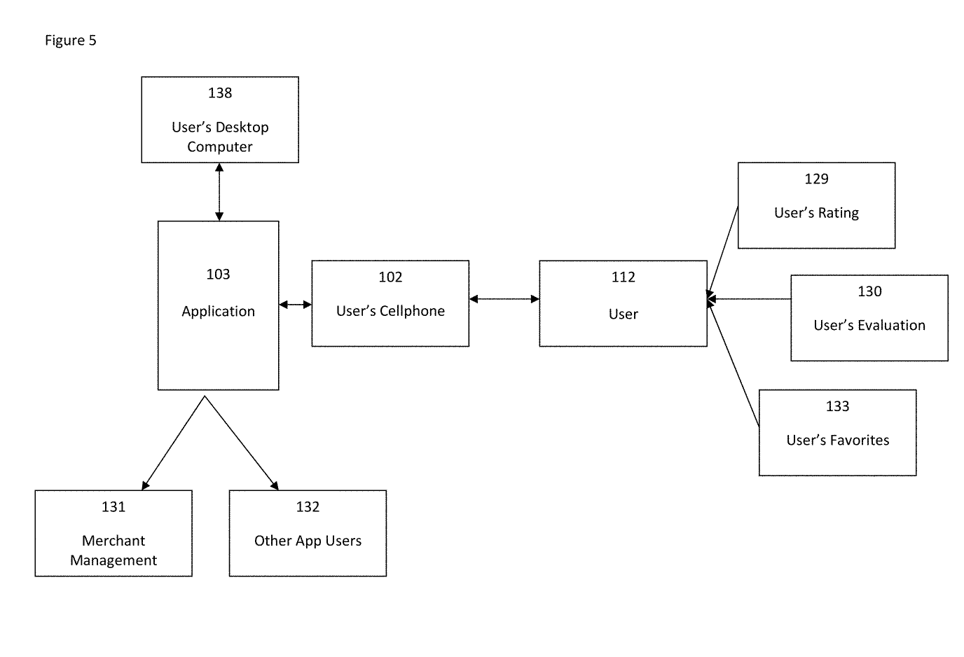

FIG. 6 illustrates screen displays that a mobile application (“app”) may generate and display upon a user's arrival at a merchant's place of business.

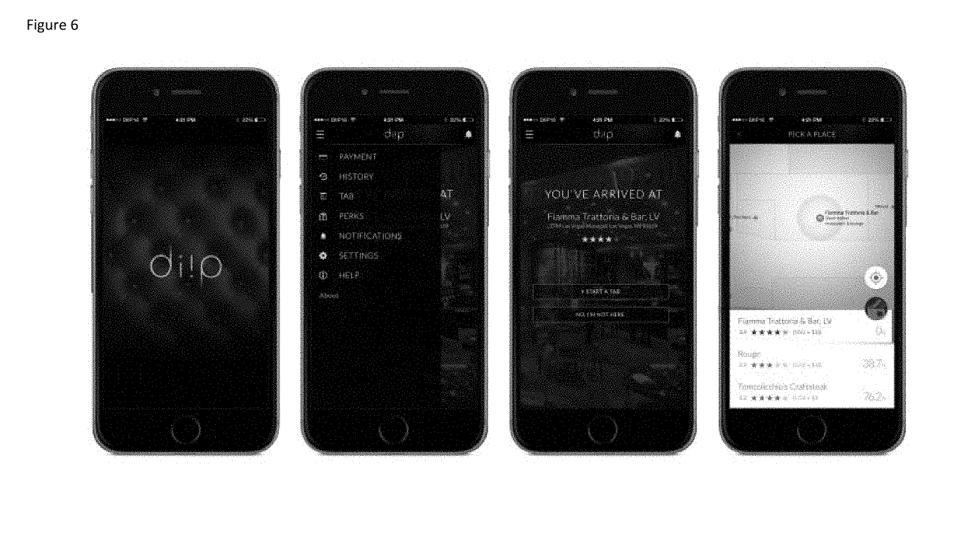

FIG. 7 illustrates screen displays that a mobile app may generate when a user begins to open a new tab at a merchant's place of business, including generating a unique random identifier code, and an open tab associated with the user through the unique random identifier code.

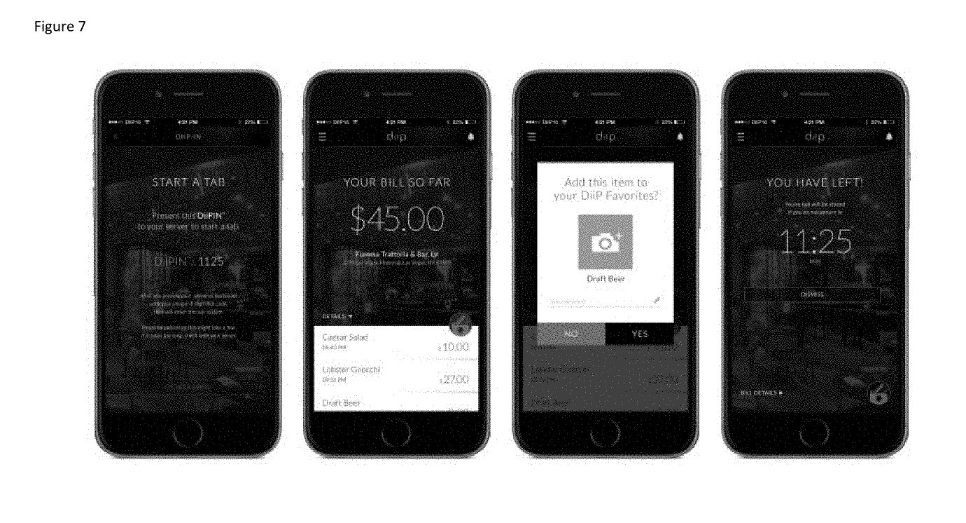

FIG. 8 illustrates screen displays prompting the user to pay his or her final bill, along with prompting him or her to rate the service and explain his or her rating.

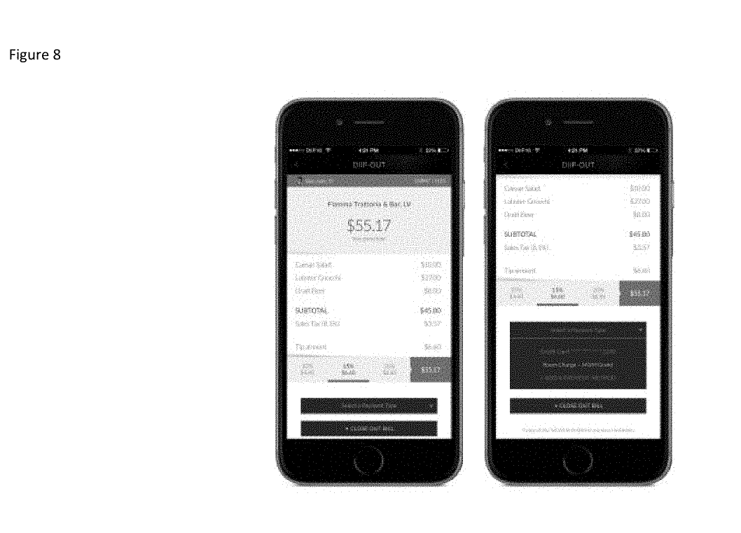

FIG. 9 illustrates screen displays prompting the user to input his or her various payment type information.

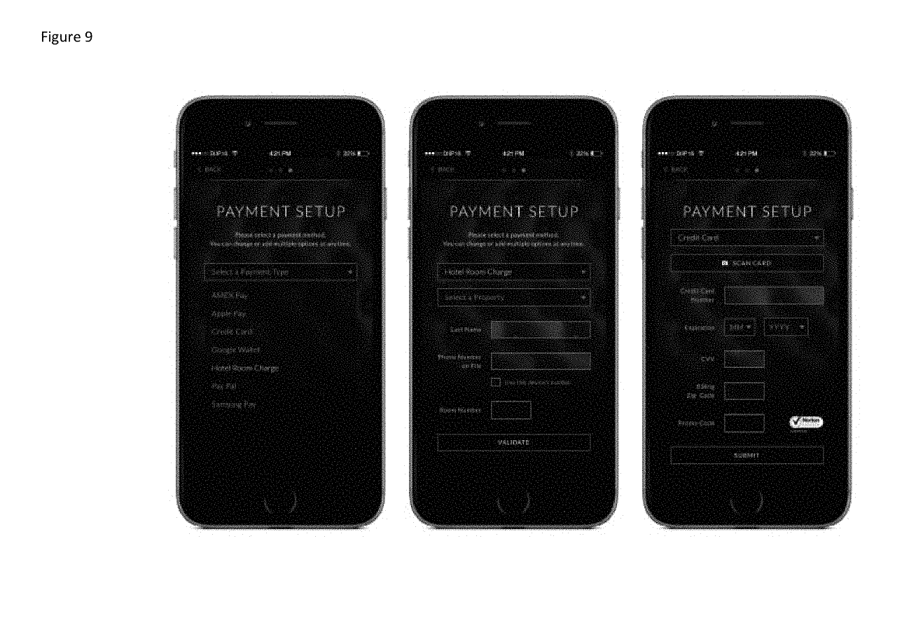

FIG. 10 illustrates example screen displays prompting the user to rate and/or describe his or her experience and server (e.g. waitress, waiter, etc.) at the merchant's place of business.

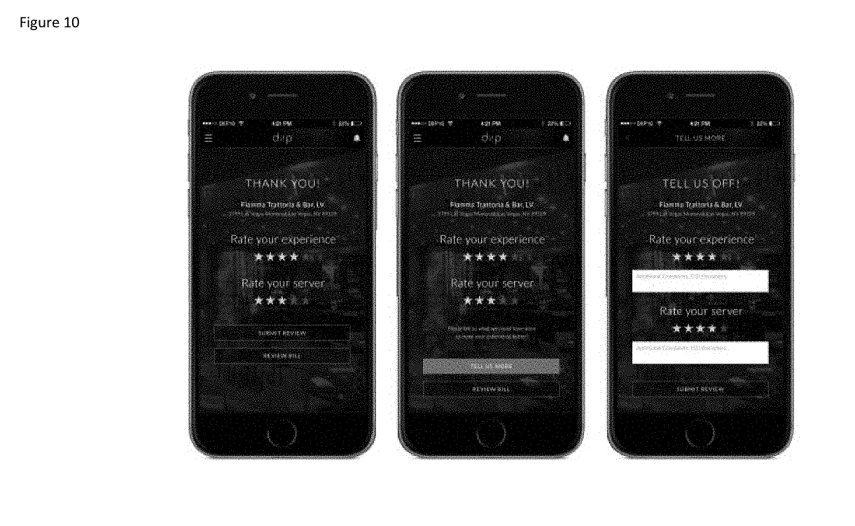

FIG. 11 illustrates example screen displays prompting the user to engage with a transportation service in the event that the user has ordered a minimum number of alcoholic drinks.

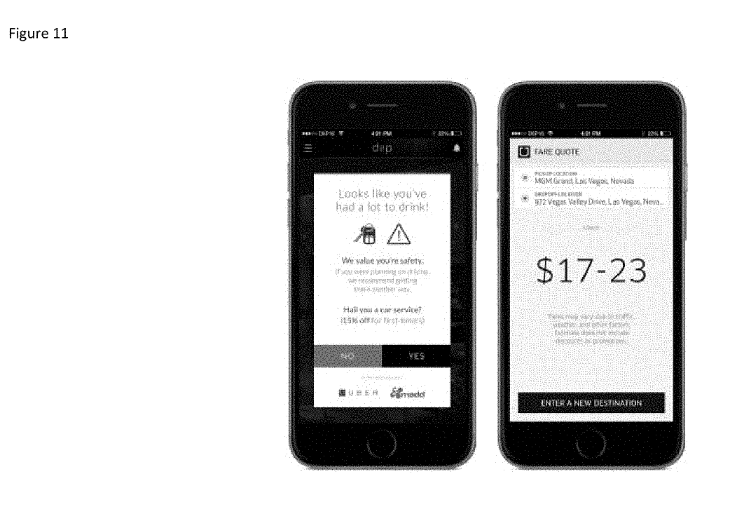

### DETAILED DESCRIPTION

The system and method of the application allows customers to remain anonymous to a merchant and its POS 106 even if they wish to pay with credit cards or other electronic payment services.

Referring to the Figures, wherein like numerals indicate corresponding parts throughout the several views:

The method for anonymous mobile payment first requires a user 112 to open a user account 134 through a mobile application 103 and record his or her payment information 111. Simultaneously, a merchant will associate its account with its own payment receipt data at its point of sale (POS) computer 106. When a user arrives at a merchant's place of business, the Global Positioning System (GPS) 109 of the user's mobile device 102 will determine that the user is at the merchant's place of business. Then, a unique random identifier code is requested from the server 122. The server 122 generates the unique random identifier code 104 with a proprietary algorithm 134. The unique random identifier code 104 is linked to the user 112 and the user's tab 120 open at the merchant's point of sale (POS) computer 106. The user 112 then places orders for menu items 136 with the waiter to add to the tab 120.

When the user 112 desires to leave the merchant's place of business, his or her mobile device 102 will request to pay the user's tab 120 that is associated with the unique random identifier code 104. The application will then obtain a current total tab amount and display that amount on the user's mobile device 102. The application 103 will calculate an extended total tab amount by using the current total tab amount, and calculating and adding any applicable taxes and fees. The application 103 will then communicate with the merchant POS system 106 to invoke a payment network gateway computer to cause payment of the extended total tab amount to be authorized from the user account 134. Then, the application 103 will communicate to the mobile device 102 that the payment of the estimated total tab amount is successfully authorized. A final total tab amount will then be obtained, and payment will be provided from the user account 134, through a payment network gateway computer 108, to the merchant account. Finally, the application will communicate a confirmation to the user's mobile device 102 that the estimated total tab amount was successfully paid.

This method may further include withholding from the merchant any personally identifying information of the user. This method may further include generation of the unique random identifier code 104 by using an algorithm which is not disclosed to the merchant or to the user.

This method may further include the generation of a new unique random identifier code 104 for each new tab opened by the user.

This method may further include a determination of the number of alcoholic drinks 126 ordered by the user linked to the unique random identifier code 104. If the number of alcoholic drinks 126 ordered exceeds a calculated minimum determined by an algorithm 127 based upon the number and sex of the individuals in the user's party 124, the user is then prompted to initiate a transportation service request.

This method may further include prompting the user 112 to rate the service at the merchant on a scale of zero to five stars. The number of stars selected by the user is recorded and communicated to the management of the merchant 131. This method may further include prompting the user to provide an evaluation 130 of the service for the rating, and recording the evaluation 130 authored by the user.

This method may further include splitting the merchant tab 120 by determining the number of individuals that are associated with the merchant tab, and then dividing the tab based upon either the order of each individual associated with the original tab, or allocating costs and fees chosen by the user.

This method may further include the calculation of the total tab amount with a gratuity amount incorporated.

The present disclosure further provides for a method for anonymous mobile payment which first requires a user 112 to open a user account 134 through a mobile application 103 and record his or her payment information 111. Simultaneously, a merchant will associate its account with its own payment receipt data at its point of sale (POS) computer 106. When a user arrives at a merchant's place of business, the Global Positioning System (GPS) 109 of the user's mobile device 102 will determine that the user is at the merchant's place of business. Then, a unique random identifier code is requested from the server 122. The server 122 generates the unique random identifier code 104 with a proprietary algorithm 134. The unique random identifier code 104 is linked to the user 112. The application 103 then prompts the user to take a self-portrait photo 123 and communicate with the merchant's point of sale computer 106 to open a tab identified on the computer by the self-portrait photo 123. The unique random identifier code 104 and the self-portrait photo 123 are then linked to the user's tab 120 open at the merchant's point of sale (POS) computer 106. The user 112 then places orders for menu items 136 with the waiter to add to the tab 120.

When the user 112 desires to leave the merchant's place of business, his or her mobile device 102 will request to pay the user's tab 120 that is linked to the unique random identifier code 104 and the self-portrait photo 123. The application will then obtain a current total tab amount and display that amount on the user's mobile device 102. The application 103 will calculate an extended total tab amount by using the current total tab amount, and calculating and adding any applicable taxes and fees. The application 103 will then communicate with the merchant POS system 106 to invoke a payment network gateway computer to cause payment of the extended total tab amount to be authorized from the user account 134. Then, the application 103 will communicate to the mobile device 102 that the payment of the estimated total tab amount is successfully authorized. A final total tab amount will then be obtained, and payment will be provided from the user account 134, through a payment network gateway computer 108, to the merchant account. Finally, the application will communicate a confirmation to the user's mobile device 102 that the estimated total tab amount was successfully paid.

This method may further include withholding from the merchant any personally identifying information of the user. This method may further include generation of the unique random identifier code 104 by using an algorithm which is not disclosed to the merchant or to the user.

This method may further include the generation of a new unique random identifier code 104 and the self-portrait photo 123 for each new tab opened by the user.

This method may further include a determination of the number of alcoholic drinks 126 ordered by the user linked to the unique random identifier code 104 and the self-portrait photo 123. If the number of alcoholic drinks 126 ordered exceeds a calculated minimum determined by an algorithm 127 based upon the number and sex of the individuals in the user's party 124, the user is then prompted to initiate a transportation service request.

This method may further include prompting the user 112 to rate the service at the merchant on a scale of zero to five stars. The number of stars selected by the user is recorded and communicated to the management of the merchant 131. This method may further include prompting the user to provide an evaluation 130 of the service for the rating, and recording the evaluation 130 authored by the user.

This method may further include splitting the merchant tab 120 by determining the number of individuals that are associated with the merchant tab, and then dividing the tab based upon either the order of each individual associated with the original tab, or allocating costs and fees chosen by the user.

This method may further include the calculation of the total tab amount with a gratuity amount incorporated.

Obviously, many modifications and variations of the present invention are possible in light of the above teachings and may be practiced otherwise than as specifically described while within the scope of the appended claims.

Structural and Functional Overview

In an embodiment, mobile devices are connected to the merchant POS 106 at their place of business using a cellular network or Wi-Fi connection 101. Mobile devices, including a user's cellphone 102, may generally include smart phones, tablet computers, other handheld computers, laptop computers, netbook computers, and ultrabook computers. Such mobile devices 102 may operate using any known operating system including Apple iOS, Android, and Microsoft Windows among others. The mobile device 102, may host a payment application 103, the functions of which are further described herein. In general, the application 103 may be configured to generate an anonymous unique random identifier code 104, which may be associated with the user's open tab 120 at a given merchant and may be valid for the user's purchase of as many menu items 136 as desired until they elect to close their tab 120 with the merchant and a merchant point of sale computer system 106. The unique random identifier code 104 may be generated via a proprietary algorithm 134 that may use the user, the restaurant they are currently visiting, the date and time of the visit, as well as other attributes of the visit. The user may use the application 103 to pay its tab 120 to the merchant anonymously, as the merchant is only ever in contact with the unique random identifier code 104 and self-portrait 123.

The merchant LAN 105 may be coupled to a merchant point-of-sale (POS) computer 106. The merchant POS computer 106 may be configured to perform point-of-sale functions, such as opening guest tabs 120, entering orders for food, beverages or merchandise, revising or cancelling orders, printing guest checks, associating guest checks with the random identifier code 104, and any other functions.

In an embodiment, the user creates an account 134 through the application 103, which includes the user's payment information 111. The user's payment information 111 may include, but is not limited to, credit card and debit card numbers, hotel room charge information, or mobile payment information such as Apple Pay, PayPal, Google Wallet, or Samsung Pay or any other electronic payment information. The merchant may also have its own account associated with the application 103, which includes the merchant's payment receipt information 108. The user opens the application 103 on his mobile device 102. The mobile device 102 communicates and receives information from the Global Positioning System (GPS) 109 enabled on the device 102 and determines whether the user is located at a participating merchant. If the user is located at a participating merchant, the merchant name appears on the mobile device screen. The user then selects the participating merchant and indicates that he or she desires to start a tab at that merchant. The application 103 then communicates with the merchant POS 106, which generates a one-time use or unique random identifier code 104 that is unique to that user's visit to that merchant at that time. The merchant POS 106 then communicates the unique random identifier code to the application 103 on the user's device 102. The user may then communicate the unique random identifier code 104 to the waiter. When opening a tab on the merchant's point of sale computer 106, the waiter will be prompted to input the code 104 which will then be associated with the tab. The merchant's point of sale computer 106 then communicates with the application 103, through the merchant LAN 105, the public internet and the server 122. At all times, the merchant may only identify the user through his or her unique random identifier code 104. The mobile device will display the user's tab throughout his or her stay at the merchant's place of business.

During the user's stay at the merchant's place of business, within the mobile device application 103, the user may select a line item on their order as a “favorite” 133 (e.g. entrees, side dishes, drink types). These items will be saved in the application's user database 110 on the server 122 for future access and reordering during future visits to the same merchant or others. The user may access these favorites by logging into the mobile app 103, or via a desktop computer 138. This favorites information 133 may then be made available to merchants, and regional or local vendors and suppliers, to improve their processes. When the user is ready to close out his or her tab and make payment, the user may indicate as such on his or her mobile device through the app 103. The app 103 then calculates a final total payment amount which may use the tab information 120, applicable taxes and tip amount. The app 103 may then communicate the user's electronic payment information through the merchant LAN and public internet. The merchant's tab is paid through the app, which communicates with the merchant point of sale computer 106.

After paying his or her tab, the user is prompted to rate his experience and service at the merchant's place of business on a scale of zero to five stars. If the rating is less than or equal to three stars, the user is prompted to describe the reason for giving that rating and the app records the user's description. The rating is immediately communicated, among other recipients, to management of the restaurant and other users of the app, by the app server via integrated text messaging, email, and/or other electronic communication services. If the user has ordered more than a minimum number of drinks, calculated by an algorithm based on, among other factors, the user's gender, the user is prompted to engage with a transportation service. If the user accepts the suggestion, the app facilitates communication with one or more transportation services. Finally, if the user desires to share the tab with other users of the same app, the app will split the tab based on each individual's order at the merchant's place of business.

What is claimed is:

1. In a merchant's computer system including a merchant point-of-sale (“POS”) computer joined to a mobile device of a user by at least one data network, a method of making an anonymous payment comprising the steps of:
generating a unique random identifier code;
generating a user's tab in the POS computer;
associating the unique random identifier code with the mobile device of a user;
associating the unique random identifier code with the user's payment information including a user account;
associating the unique random identifier code with the user's tab open at a merchant point-of-sale computer;
selecting items to add to the user's tab;
receiving a request from the mobile device of the user to pay the user's tab open at the merchant point-of-sale computer including a merchant account;
associating the current total tab amount with the random identifier code; and
communicating with a payment network gateway computer to cause payment of the total tab amount to be captured for the merchant from the payment account of the user in which the user's payment account data is associated with the user account identified as payer and in which a merchant account associated with the merchant is identified as beneficiary.

2. A method for making an anonymous payment at a merchant's place of business using an anonymous mobile payment system, the method comprising the steps of:
Associating a user account with user payment data inserted by a user;
associating a merchant account with merchant payment receipt data;
utilizing the Global Positioning System (GPS) of a user's mobile device to determine that the user is at a merchant's place of business;
generating a unique random identifier code;
associating the unique random identifier code with the user's mobile device;
associating the unique random identifier code with a user's tab open at a merchant's point-of-sale (“POS”) computer, the user's tab including a current total tab amount;
receiving a request from the mobile device of the user to pay the user's tab identified by the unique random identifier code;
obtaining the current total tab amount for the user's tab;
displaying the current total tab amount on the user's mobile device;
determining an extended total tab amount based on the current total tab amount and applicable taxes and fees;
communicating with the merchant POS computer to invoke a payment network gateway computer to cause payment of the extended total tab amount to be authorized from the user account;
communicating to the mobile device of the user that that payment of the estimated total tab amount is successfully authorized;
obtaining a final total tab amount for the user's tab associated with the unique random identifier code;
providing the payment from the user account to the merchant account through a payment network gateway computer; and
communicating with the user a confirmation that the estimated total tab amount was successfully paid.

3. The method of claim 2, further comprising the step of adding items to the user's tab after generating the unique random identifier code.

4. The method of claim 2, further comprising the step of withholding from the merchant any personally identifying information of the user.

5. The method of claim 2, further comprising the step of generating the unique random identifier code by using an algorithm which is not disclosed to the merchant or to the user, securing the anonymity of the user for the transaction.

6. The method of claim 2, further comprising the step of generating a new unique random identifier code for each new tab opened by the user.

7. The method of claim 2, further comprising the step of:
determining how many alcoholic drinks were ordered by the user associated with the unique random identifier code;
prompting the user to initiate a transportation service request in the event that the number of alcoholic drinks ordered exceeds a calculated minimum determined by an algorithm based upon, among other factors, the number and sex of the individuals in the user's party; and
facilitating communication with the transportation service via a transportation service Application Program Interface (“API”).

8. The method of claim 2, further comprising the steps of:
prompting the user to rate the service at the merchant on a scale of zero to five stars;
recording the number of stars selected by the user; and
communicating the number of stars selected by the user to the management of the merchant.

9. The method of claim 8, further comprising the step of prompting the user to provide an evaluation of the service for the number of stars rating; and recording the evaluation authored by the user.

10. The method of claim 2, further comprising the steps of:
determining how many individuals are associated with the merchant tab; and
splitting the merchant tab based on one of: (i) the order of each individual associated with the original merchant tab; and (2) an allocation of costs and fees chosen by the user.

11. The method of claim 2, further comprising the step of incorporating a gratuity amount into the total tab amount.

12. The method of claim 2, further comprising the steps of:
Allowing the user to select items on a merchant's menu as a favorite;
Saving the selected favorite menu items into the user's account for future access; and
Providing “favorites” information to the merchant for analytical purposes.

13. In a merchant's computer system joined to a mobile device of a user and a merchant point-of-sale (“POS”) computer by at least one data network, a method of making an anonymous payment comprising the steps of:
generating a unique random identifier code;
associating the unique random identifier code with the mobile device of a user;
prompting the user to take a self-portrait photo with the mobile device;
associating the unique random identifier code and the self-portrait photo with the user's payment information;
associating the unique random identifier code and the self-portrait photo with the user's tab open at a merchant point-of-sale computer;
selecting items to add to the user's tab;
receiving a request from the mobile device of the user to pay a tab open at the merchant point-of-sale computer;
associating the current total tab amount with the random identifier code and/or the self-portrait photo; and
communicating with a payment network gateway computer to cause payment of the total tab amount to be captured for the merchant from the payment account of the user in which the user's payment account data is associated with the user account identified as payer and in which a merchant account associated with the merchant is identified as beneficiary.

14. A method for making an anonymous payment at a merchant's place of business using an anonymous mobile payment system, the method comprising the steps of:
associating a user account with user payment data inserted by the user;
associating a merchant account with merchant payment receipt data;
utilizing a mobile device's Global Positioning System (GPS) to determine that the user is at a merchant's place of business;
generating a unique random identifier code;
prompting the user to take a self-portrait photo with the mobile device;
associating the unique random identifier code and/or self-portrait photo with the mobile device of a user;
communicating with the merchant's point-of-sale computer to open a tab identified on the computer by the self-portrait photo;
associating at least one of the unique random identifier code and the self-portrait photo with a user's tab open at a merchant's point-of-sale (“POS”) computer,
receiving a request from the mobile device of the user to pay the tab identified by the unique random identifier code;
obtaining a current total tab amount for the user's tab;
displaying the current total tab amount on the user's mobile device;
determining an extended total tab amount based on the current total tab amount and applicable taxes and fees;
communicating with the merchant's POS computer to invoke a payment network gateway computer to cause payment of the extended total tab amount to be authorized from the user account;
communicating to the mobile device of the user that the payment of the estimated total tab amount is successfully authorized;
obtaining a final total tab amount for the user's tab associated with at least one of the unique random identifier code and self-portrait photo;
providing the payment from the user account to the merchant account through a payment network gateway computer, and
communicating with the user a confirmation that the estimated total tab amount was successfully paid.

15. The method of claim 14, further comprising the step of adding items to the user's tab after generating the unique random identifier code.

16. The method of claim 14, further comprising the step of withholding from the merchant any personally identifying information of the user.

17. The method of claim 14, further comprising the step of generating the unique random identifier code by using an algorithm which is not disclosed to the merchant or to the user, securing the anonymity of the user for the transaction.

18. The method of claim 14, further comprising the step of generating a new unique random identifier code for each new tab opened by the user.

19. The method of claim 14, further comprising the step of:
determining how many alcoholic drinks were ordered by the user associated with unique the random identifier code;
prompting the user to initiate a transportation service request if the number of alcoholic drinks ordered exceeds a calculated minimum determined by an algorithm based upon, among other factors, the number and sex of the individuals in the user's party; and
facilitating communication with the transportation service via a transportation service Application Program Interface (“APP”).

20. The method of claim 14, further comprising the steps of:
prompting the user to rate the service at the merchant on a scale of zero to five stars;
recording the number of stars selected by the user;
communicating the number of stars selected by the user to the management of the merchant.

21. The method of claim 20, further comprising the step of prompting the user to provide an evaluation of the service for the number of stars rating; and recording the evaluation authored by the user.

22. The method of claim 14, further comprising the steps of:
determining how many individuals are associated with the merchant tab; and
splitting the merchant tab based on one of: (i) the order of each individual associated with the original merchant tab; and (2) an allocation of costs and fees chosen by the user.

23. The method of claim 14, further comprising the step of incorporating a gratuity amount into the total tab amount.

24. The method of claim 14, further comprising the steps of:
Allowing the user to select items on a merchant's menu as a favorite;
Saving the selected favorite menu items into the user's account for future access; and
Providing “favorites” information to the merchant for analytical purposes.
